(19) United States
(12) Patent Application Publication
(10) Pub. No.: US 2002/0188737 A1
(43) Pub. Date: Dec. 12, 2002

(54) Data relay apparatus and method thereof

(76) Inventor: Jae-Hong Park, Yongin-city (KR)

Correspondence Address: Robert E. Bushnell, Suite 300, 1522 K. Street, N.W., Washington, DC, 20005-1202, US

(21) Appl. No.: 10/104,020

(22) Filed: Mar. 25, 2002

(30) Foreign Application Priority Data
Jun. 7, 2001 (KR) 31739/2001

(51) Int. Cl. G06F 15/16

(52) U.S. Cl. 709/229

(57) ABSTRACT

In a data relay apparatus and method, a detecting unit detects the connection status and/or the types of an external apparatus, a user's terminal, and an output device. The user selects a source apparatus having data from among the connected apparatuses, and a destination apparatus. A controller determines whether the type of the source apparatus having the data is the same as the type of the destination apparatus. If the two apparatuses are of different types, the controller outputs a control signal for converting the received data into a form suitable for the destination apparatus. The converted data is transmitted to the destination apparatus through an interface unit. Accordingly, it is possible to send the data directly between the external apparatuses without passing the data through a user terminal, such as a computer.

### CLAIM OF PRIORITY

This application makes reference to, incorporates the same herein, and claims all benefits accruing under 35 U.S.C. §119 from an application for DATA RELAY APPARATUS AND METHOD THEREOF earlier filed in the Korean Industrial Property Office on Jun. 7, 2001, and there duly assigned Serial No. 31739/2001 by that Office.

### BACKGROUND OF THE INVENTION

1. Technical Field

The present invention relates to a data relay apparatus and a method thereof, and more particularly to a data relay apparatus and a method thereof which operate between a user's terminal and a plurality of external apparatuses.

2. Related Art

As digital technology develops, most media data such as image and sound can be edited, reproduced, and recorded in a computer. Accordingly, technology for transmitting data from the media to the computer or from the computer to the media has been constantly developed. Data transmission between the computer and the media is accomplished through an input/output apparatus provided in the computer.

For example, image data stored in the computer can be stored in a removable memory, or the image data stored in the memory can be stored in the computer. Moreover, the data can be transmitted to the removable memory via the computer. However, it is inefficient for image data to be transmitted via the computer when a user wants to store the image data, recorded in one memory, in another memory without having a special data conversion procedure.

On the other hand, when the data is transmitted between the memories using different data formats, the data stored in a sending apparatus should be converted into a format suitable for a receiving apparatus. At present, the data conversion is performed in the computer. Thus, when each media uses a different data format, the data format must be converted in the computer. This kind of inconvenience also exists when the media data, recorded in the media, is outputted.

In a case of a memory stick used as a storing device for a digital camera, firstly, the image data stored in the memory stick is transmitted to the computer. Then, the image data received in the computer is changed to a printing format suitable for a printer, and is transmitted to a printer, and then the printer prints out the image. Therefore, without the computer, it is impossible to transmit the data directly between the memory and another element, that is, from the memory to an output apparatus, such as the printer, and from an input apparatus, such as a scanner, to the memory.

To solve the above-mentioned problems, an apparatus that provides an interface for the computer and the memory has been introduced. Yet, the apparatus does not eliminate the above-mentioned problems in terms of intervention of the computer, except that the conversion of the data is done in the apparatus.

A system comprises a controller, a read only memory (ROM), a random access memory (RAM), and an image-processing unit. The controller controls the interface with the individual media. The ROM stores a program associated with the operation of the controller. The RAM stores the data received from the media. The image-processing unit converts the image data received from the media.

In such a system, the interface between the system and the media is available, but interface between the media is not available. Thus, to perform the interface between the individual media, the data is input from a certain media, uploaded to the computer, and then stored in another media.

### SUMMARY OF THE INVENTION

The present invention has been developed to overcome the above-mentioned problems of the related art. Accordingly, it is an object of the present invention to provide a data relay apparatus and a method thereof, which are capable of transmitting data between external apparatuses, or between an external apparatus and an output apparatus, without intervention by a user terminal, such as a computer.

The above object is accomplished by a data relay apparatus which includes: an external apparatus interface unit, connected with a plurality of external apparatuses, for sending data to and receiving data from the external apparatuses; a user terminal interface unit connected to a user's terminal for sending data to and receiving data from the user's terminal; a manipulating panel unit for receiving a command word from a user; and a controller for controlling transmission of the data between the external apparatus and the user's terminal and/or between the external apparatuses in accordance with the received command word.

It is preferable that the data relay apparatus according to the present invention include a converter unit for converting a format of the data. The controller outputs a control signal to the converter unit for converting the format of the data when the controller receives a command from the user to transmit the data between the external apparatus and the user's terminal and/or between the external apparatuses. Moreover, the data relay apparatus has a detecting unit for detecting connection of the external apparatuses and types of the connected external apparatuses, and a storage unit for storing the data. If the detecting unit detects that a plurality of external apparatuses are connected, and that the types of the connected external apparatuses are different, and the controller is commanded by the user to transmit the data from a first external apparatus to a second external apparatus, then the controller outputs to the converter unit a control signal for converting the received data from the first external apparatus to a form suitable for the second external apparatus, for saving the converted data in the storage unit, and for transmitting the data stored in the storage unit to the second external apparatus.

In addition, the data relay apparatus includes an output device interface unit, to which a printing apparatus is connected, for transmitting the data to the printing apparatus. The controller outputs, to the converter unit, a control signal for converting the data received from the external apparatus and/or the user's terminal to a form appropriate for the external apparatus, and for transmitting the converted data to the output device through the output device interface, when the controller receives from the user a command word calling for the output of the data received from the external apparatus and/or the user's terminal.

By using the data relay apparatus according to the present invention, it is possible to transmit data between the external apparatuses, and between a user terminal and either the external apparatus or an output device such as a printer. Moreover, by transmitting the data after converting the format so that it is suitable for each apparatus, data transmission and conversion can be performed without intervention by a computer.

On the other hand, a data relay method according to the present invention includes the steps of: (a) determining whether external apparatuses are connected; (b) receiving the data from one of the external apparatuses when it is confirmed that more than two external apparatuses are connected; and (c) transmitting the data received from a source to a destination, including an output device such as a printer, a user's terminal, and another external apparatus in accordance with the user's choice.

Preferably, step (a) further includes a step of confirming the type of each connected external apparatus; and step (b) further includes a step of converting the data received from one external apparatus to a form suitable for another external apparatus. The converting step is performed when receiving, from the user, a command word for data transmission from a first external apparatus to a second outer apparatus when the type of the first external apparatus and the type of the second external apparatus are confirmed to be different.

By using the data relay method according to the present invention, data transmission and conversion between the external apparatuses, and between an external apparatus and an output device (such as a printer), can be performed by confirming the connection between the apparatuses and/or device without intervention by the computer.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference numerals indicate the same or similar components, and wherein:

FIG. 1 is a block diagram showing the construction of the system for an interface with a media;

FIG. 2 is a block diagram showing the construction of the data relay apparatus according to a preferred embodiment of the present invention; and

FIG. 3 is a flow chart showing operation of the data relay apparatus according to the preferred embodiment of the present invention.

### DESCRIPTION OF THE PREFERRED EMBODIMENT

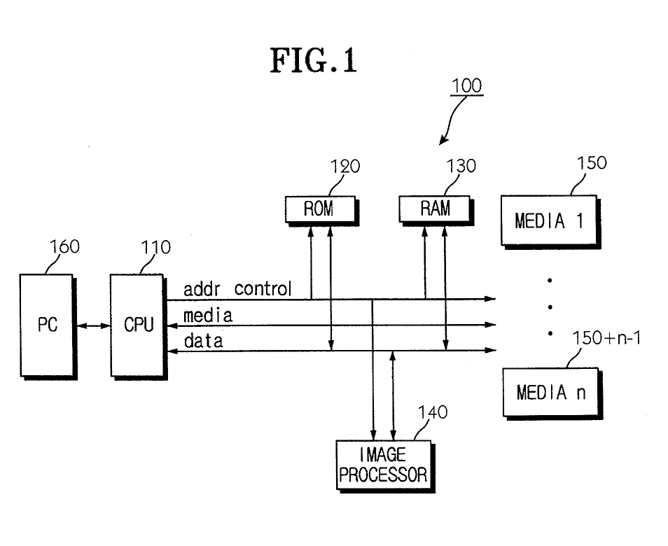

This invention will now be described in more detail with reference to the drawings, in which FIG. 1 is a block diagram illustrating a system for an interface with a media. Referring to FIG. 1, the system 100 comprises a controller 110, a ROM 120, a RAM 130, and an image-processing unit 140. The controller 110 controls the interface with the individual media 150, . . . , 150+n−1. The ROM 120 stores a program associated with the operation of the controller 110. The RAM 130 stores the data received from the media 150, . . . , 150+n−1. The image-processing unit 140 converts the image data received from the media 150, . . . , 150+n−1.

In this systems, the interface between the system 100 and the media 150, . . . , 150+n−1 is available, but interface between the media 150, . . . , 150+n−1 is not available. Thus, to perform the interface between the individual media, the data is input from a certain media, and uploaded to the computer 160, and then stored in another media.

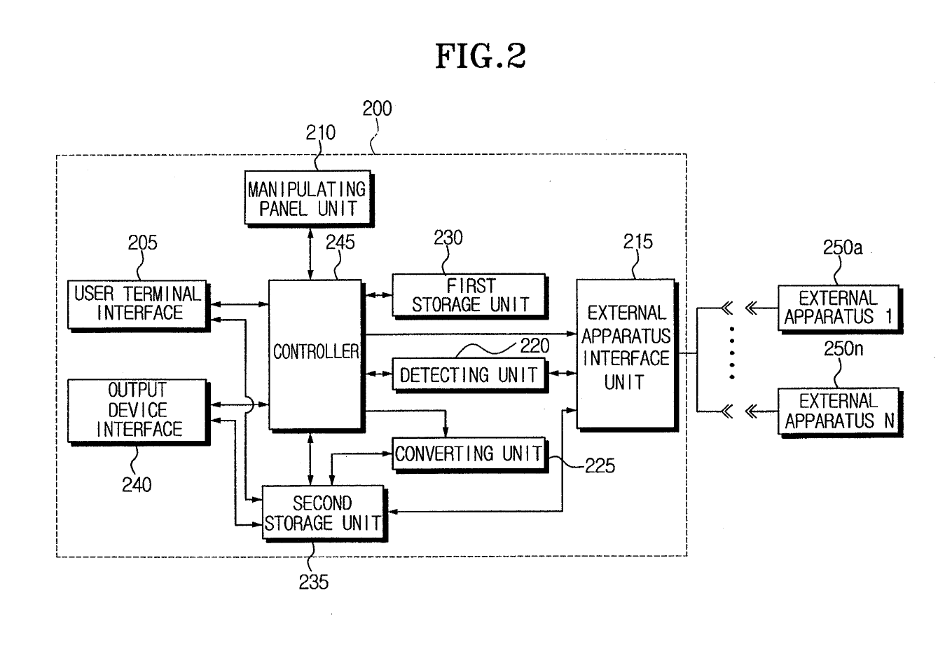

FIG. 2 is a block diagram showing the construction of the data relay apparatus according to the preferred embodiment of the present invention. Referring to FIG. 2, a data relay apparatus 200 according to the present invention comprises: a user terminal interface unit 205; a manipulating panel unit 210; an external apparatus interface unit 215; a detecting unit 220; a converting unit 225; a first storage unit 230; a second storage unit 235; an output device interface unit 240; and a controller 245.

The user terminal interface unit 205 is connected to a user terminal having an information processing function, such as a computer, a PDA, or a mobile phone, and provides the user terminal with a means for data transmission and reception. An arrangement in which the user terminal is a computer will now be described.

The manipulating panel unit 210 provides a means for receiving a command from the user. The user can control operation of the data relay apparatus 200 by using the manipulating panel unit 210. In other words, the number and the type of the connected external apparatuses, the connection of an input/output apparatus such as a scanner or a printer, and the connection of the computer are indicated in the manipulating panel unit 210. The user can select a source that stores data and a target or destination that receives data among apparatuses indicated in the manipulating panel unit 210. Moreover, the user can designate, by means of the manipulating panel unit 210, the data that the user wants to transmit.

The external apparatus interface unit 215 is connected to a plurality of external apparatuses 250a to 250n, and provides for data transmission and reception with respect to the external apparatuses 250a to 250n. A port capable of accommodating more than one different type of outer apparatus is formed at the external apparatus interface unit 215. As described below, the external apparatus 250a to 250n can be a memory such as a memory stick, a compact flash memory card, or a smart media.

The detecting unit 220 detects the connection of the external apparatuses 250a to 250n, and the types of the connected apparatuses 250a to 250n. The detecting unit 220 checks the port of the external apparatus interface 215, and detects the types of the external apparatuses 250a to 250n connected to the port. In this procedure, it is preferable to know the type of and/or the form of data used in the corresponding external apparatuses 250a to 250n.

The converting unit 225 converts the data received from the external apparatuses 250a to 250n into a format that can be outputted by a printer or a monitor and/or a form suitable for other external apparatuses in accordance with a control command from the controller 245. This data format conversion includes format conversion (for example, conversion from an image data of BMP format to image data of the format of JPEG, TIFF etc.) of the data with the same type. Yet, if the converting unit 225 receives a control command for transmission of the data between the external apparatuses 250a to 250n, then the converting unit 225 converts the received data to a protocol or a data packet suitable for the external apparatuses 250a to 250n. In addition, the converting unit 225 performs data compression, analog-to-digital (A/D) conversion, and digital-to-analog (D/A) conversion.

Firmware related to the operation of each component is stored in the first storage unit 230. The first storage unit 230 is, preferably, a non-volatile memory, such as a ROM. A variety of data and user data are stored in the second storage unit 235. The second storage unit 235 is, preferably, a volatile memory, such as a RAM.

The output device interface unit 240 is connected to an output apparatus, such as a printer, and provides the output apparatus with a means for data transmission and/or reception.

The controller 245 controls the operations of components of the data relay apparatus 200. The user can input a command through the manipulating panel unit 210, and the controller 245 outputs a control signal, corresponding to the command from the user, to the components of data relay apparatus 200 in accordance with the firmware stored in the first storage unit 230.

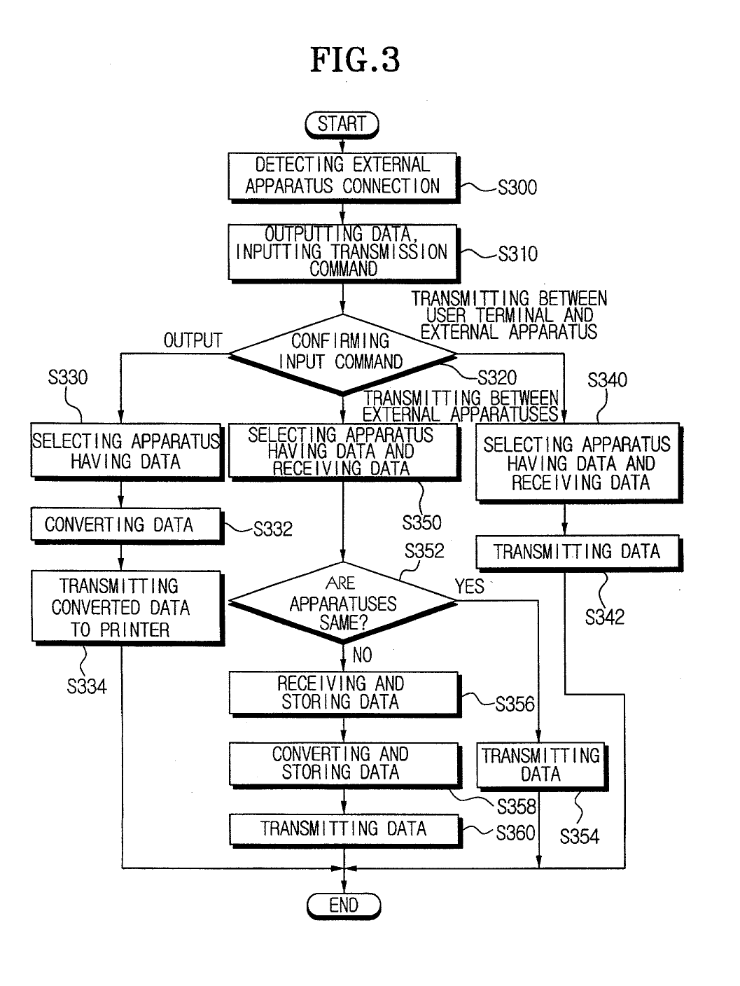

FIG. 3 is a flow chart showing the operation of the data relay apparatus according to the preferred embodiment of the present invention. Referring to FIG. 3, the detecting unit 220 checks for connection of the external apparatuses 250a to 250n (S300). In this case, when the external apparatuses 250a to 250n are connected to the port disposed at the external apparatus interface unit 215, the connection can be confirmed by detecting a connection signal generated from the port. Alternatively, the connection of the external apparatuses 250a to 250n can be confirmed by periodically generating a detecting signal via the detecting unit 220.

Preferably, the detecting unit 220 detects not only the connection of the outer apparatuses 250a to 250n, but also the types of the connected external apparatuses 250a to 250n and the form of files used in the external apparatuses 250a to 250n. The types of external apparatuses 250a to 250n can be confirmed, by the name of the connected apparatus, the manufacturer's name, the model name, and a command words collection. Once the types of the external apparatuses 250a to 250n are determined, the types of files used in the external apparatuses 250a to 250n can be confirmed by using a lookup table that has been developed and stored in advance. In addition, information about the types of files used in the external apparatuses 250a to 250n can be transmitted from the external apparatuses 250a to 250n.

Preferably, the connected external apparatuses 250a to 250n are indicated in an indication window of the manipulating panel unit 210. Therefore, the user can confirm the number and the types of the external apparatuses 250a to 250n connected through the manipulating panel unit 210, and can input a command word in accordance with the connection of the external apparatuses 250a to 250n.

The user can input a command, such as output data, data transmission between external apparatuses 250a to 250n, and data transmission between the external apparatus and user terminal including the computer, through the manipulating panel unit 210 (S310). The controller 245 confirms the command inputted by the user (S320), and controls the operation of each component in accordance with the command.

The following description relates to a case wherein the user inputs an output command. For convenience in explanation, output from the printer will be used as an example, but the data can be outputted through various output means, such as a monitor, a speaker, etc. The user selects the apparatus (for example, a user terminal such as a computer, a memory stick, or a smart media) having the data to be output through the manipulating panel unit 210 (S330).

If the data is received through the interface unit (for example, if the user selects an external unit and reception of external data through an external apparatus interface unit 215) interfacing with the selected apparatus, the controller 245 generates a control signal related to the conversion of the data for output to the converting unit 225. The converting unit 225 converts the received data to a form that can be printed by the printer (S332). The converted data is transmitted to the printer through the output device interface unit 240 (S334). It is preferable that the data received from the apparatus selected by the user, and the data converted through the above steps S330 to S336, be temporarily stored in the second storage unit 235.

Next, data transmission between the external apparatuses 250a to 250n and a user terminal will be described in great detail. For the convenience of explanation, the computer will be dealt with as the user terminal.

The user selects an external apparatus having the data to be transmitted (for example, the memory stick and the smart media) through the manipulating panel unit 210 (S340). In this case, the data receiving apparatus is a computer. On the contrary, if the user wants to transmit the data stored in the computer to the external apparatuses 250a to 250n, the user selects the computer as the data transmitting apparatus or source and the external apparatuses 250a to 250n as the data receiving apparatus or destination.

If the user selects the apparatus in the step of S340, the controller 245 outputs a control signal for transmitting data received through the external apparatus interface unit 215 to the computer through the user terminal interface unit 205, to the external apparatus interface unit 215 and the user terminal interface unit 205. The data is transmitted to the data receiving apparatus through the external apparatus interface unit 215 or user's terminal interface unit 205 (S342). In this case, it is preferable that the data conversion not be performed.

Next, the case of data transmission between the external apparatuses 250a to 250n will be dealt with. The user selects one data sending external apparatus (such as the smart media and the memory stick, etc.) and another data receiving apparatus (such as the smart media and the memory stick, etc.) at the manipulating panel unit 210 (S350). In this case, it is preferable that the user select a plurality of external apparatuses as the data receiving external apparatus.

The controller 245 determines whether the types of external apparatuses 250a to 250n selected by the user are the same (S352). If the data sending apparatus 250a to 250n and the data receiving apparatus 250a to 250n are the same (such as a smart media), then the controller 245 outputs to the external apparatus interface unit 215 a control signal for storing the data received from a first external apparatus in the second storage unit 235, and a control signal for transmitting the data received in the second storage unit 235 to the second external apparatus (S354). It is preferable that the data received from the first external apparatus be directly transmitted to the second external apparatus through the external apparatus interface 215 without being stored in the second storage unit 235.

A situation wherein the data sending external apparatuses 250a to 250n and the data receiving external apparatuses 250a to 250n are different will now be described.

In this case, the controller 245 outputs a control command for storing the data, received in the external apparatus interface unit 215, in the second storage unit 235 (S356). The converting unit 225 converts the data stored in the second storage unit 235 into a form suitable for the data receiving external apparatus, and the converted data is stored in the second storage unit 235 (S358). When the conversion and the saving of the data are finished, the controller 245 transmits the converted data stored in the second storage unit 235 to the data receiving external apparatus through the external apparatus interface unit 215 (S360).

The above steps S356 thru S360 can be applied to a case wherein the apparatus having the data is a scanner, and the data receiving external apparatuses 250a to 250n are memory sticks. In the preferred embodiment of the present invention described above, a serial/parallel port (USB, IEEE 1394) and the Blutooth can be applied to the user terminal interface unit 205, the external apparatus interface unit 215, and the output device interface unit 240. Moreover, in the preferred embodiment of the present invention, image data can be dealt with, but the technical spirit of the present invention can be applied to data conversion and transmission between multimedia devices, such as a digital camera and a camcorder, without being restricted to data conversion and transmission between memories. On the other hand, the data relay apparatus and method of the present invention can be realized as hardware and software.

In addition, the manipulating panel unit 210 included in the data relay apparatus 200 according to the present invention can be replaced by an input apparatus, such as a keyboard of the computer, and an output apparatus, such as a monitor. Furthermore, the data relay apparatus 200 according to the present invention can be created as a module that can be installed in a user terminal, such as a computer or printer. When the data relay apparatus 200 according to the present invention is installed in the printer, it is preferable that the manipulating panel unit 210 be a manipulating panel unit included in the printer.

With the data relay apparatus and method of the present invention, the data can be directly transmitted between the external apparatuses without using a user terminal, such as a computer. In addition, since data conversion and compression in accordance with the external apparatuses can be performed, the data can be shared without any restriction between the external apparatuses.

Moreover, the user can command data transmission by directly selecting the data sending apparatus and the data receiving apparatus through the manipulating panel unit 210. Thus, convenience to the user will be improved since there is no need to control the plurality of external apparatuses connected to the computer.

Although the preferred embodiments of the present invention have been described, it will be understood by those skilled in the art that the present invention should not be limited to the described preferred embodiment. Rather, various changes and modifications can be made within the spirit and scope of the present invention, as defined by the following claims.

What is claimed is:

1. A data relay apparatus, comprising;
an external apparatus interface unit connected to a plurality of external apparatuses for sending data to and receiving data from the external apparatuses;
a user terminal interface unit connected to a user terminal for sending data to and receiving data from the user terminal;
a manipulating panel unit for receiving a command word; and
a controller for controlling transmission of the data between the external apparatus and the user terminal, and between the external apparatuses, in accordance with the received command word.

2. The data relay apparatus of claim 1, wherein the external apparatuses include at least one of a memory stick, a compact flash and a smart media.

3. The data relay apparatus of claim 1, further comprising a converting unit for converting a format of the data;
wherein the controller outputs a control signal to the converting unit for converting the format of the data when the controller receives a command from the user to transmit the data between one of the external apparatuses, on one side, and one of the user terminal and another external apparatus, on another side.

4. The data relay apparatus of claim 3, further comprising:
a detecting unit for detecting connection of the external apparatuses and types of the connected external apparatuses; and
a storage unit for storing the data;
wherein, when the detecting unit detects that a plurality of external apparatuses are connected and that the types of the connected external apparatuses are different, and when the controller receives a command from the user to transmit the data from a first external apparatus to a second external apparatus, the controller outputs to the converting unit a control signal for converting the received data from the first external apparatus into a form suitable for the second external apparatus, for saving the converted data in the storage unit, and for transmitting the data stored in the storage unit to the second external apparatus.

5. The data relay apparatus of claim 4, further comprising an output device interface unit connected to an output device in order to provide for transmission of the data to the output device;
wherein, when the controller receives a command word from the user calling for output of the data received from at least one of the external apparatuses and the user terminal, the controller outputs a control signal to the converting unit for converting the data received from said at least one of the external apparatuses and the user terminal into a form appropriate for the output device, and for transmitting the converted data to the output device through the output device interface unit.

6. The data relay apparatus of claim 3, further comprising an output device interface unit connected to an output device in order to provide for transmission of the data to the output device; wherein, when the controller receives a command word from the user calling for output of the data received from at least one of the external apparatuses and the user terminal, the controller outputs a control signal to the converting unit for converting the data received from said at least one of the external apparatuses and the user terminal into a form appropriate for the output device, and for transmitting the converted data to the output device through the output device interface unit.

7. The data relay apparatus of claim 1, further comprising:
a detecting unit for detecting connection of the external apparatuses and types of the connected external apparatuses; and
a storage unit for storing the data;
wherein, when the detecting unit detects that a plurality of external apparatuses are connected and that the types of the connected external apparatuses are different, and when the controller receives a command from the user to transmit the data from a first external apparatus to a second external apparatus, the controller outputs to the converting unit a control signal for converting the received data from the first external apparatus into a form suitable for the second external apparatus, for saving the converted data in the storage unit, and for transmitting the data stored in the storage unit to the second external apparatus.

8. The data relay apparatus of claim 7, further comprising an output device interface unit connected to an output device in order to provide for transmission of the data to the output device;
wherein, when the controller receives a command word from the user calling for output of the data received from at least one of the external apparatuses and the user terminal, the controller outputs a control signal to the converting unit for converting the data received from said at least one of the external apparatuses and the user terminal into a form appropriate for the output device, and for transmitting the converted data to the output device through the output device interface unit.

9. The data relay apparatus of claim 1, further comprising an output device interface unit connected to an output device in order to provide for transmission of the data to the output device;
wherein, when the controller receives a command word from the user calling for output of the data received from at least one of the external apparatuses and the user terminal, the controller outputs a control signal to the converting unit for converting the data received from said at least one of the external apparatuses and the user terminal into a form appropriate for the output device, and for transmitting the converted data to the output device through the output device interface unit.

10. A data relay method, comprising the steps of:
(a) determining whether any external apparatuses are connected;
(b) when it is determined that at least two external apparatuses are connected, receiving data from one of said at least two external apparatuses; and
(c) transmitting the data received from said one of said at least two external apparatuses to a destination selected by a user.

11. The data relay method of claim 10, wherein the external apparatuses include at least one of a memory stick, a compact flash, and a smart media.

12. The data relay method of claim 10, wherein:
step (a) further comprises determining types of the connected external apparatuses; and
step (b) further comprises converting the data received from said one of said at least two external apparatuses to a form suitable for another of said at least two external apparatuses.

13. The data relay method of claim 12, wherein the converting step is performed upon receipt of a command word from the user calling for data transmission from a first external apparatus to a second external apparatus when the type of the first external apparatus and the type of the second external apparatus are determined to be different.

14. The data relay method of claim 13, wherein the external apparatuses include at least one of a memory stick, a compact flash, and a smart media.

15. The data relay method of claim 12, wherein the external apparatuses include at least one of a memory stick, a compact flash, and a smart media.

16. The data relay method of claim 10, wherein step (b) further comprises converting the data received from said one of said at least two external apparatuses to a form suitable for another of said at least two external apparatuses.

17. The data relay method of claim 16, wherein the converting step is performed upon receipt of a command word from the user calling for data transmission from a first external apparatus to a second external apparatus when a type of the first external apparatus and a type of the second external apparatus are determined to be different.

18. A data relay method, comprising the steps of:
(a) detecting connection of at least one external apparatus;
(b) receiving data for transmission when it is determined that said at least one external apparatus is connected; and
(c) processing a user input command to determine a destination for the received data for transmission;
wherein the user generates the user input command by selecting from a plurality of options including transmission to an output device, transmission between a user terminal and said at least one external apparatus, and transmission between two external apparatuses.

19. The data relay method of claim 18, wherein the user generates the user input command corresponding to selection of transmission to the output device, and step (c) comprises:
(c1) selecting said at least one external apparatus as the apparatus having the data for transmission;
(c2) converting the data for transmission to a form suitable for the output device; and
(c3) transmitting the converted data to the output device.

20. The data relay method of claim 18, wherein the user generates the user input command corresponding to selection of transmission between the user terminal and said at least one external apparatus, and step (c) comprises:
(c1) selecting one of the user terminal and said at least one external apparatus as a source;
(c2) selecting another of the user terminal and said at least one external apparatus as the destination; and
(c3) transmitting the data for transmission from the source to the destination.

21. The data relay method of claim 18, wherein step (a) comprises determining that at least two external apparatuses are connected, wherein the user generates the user input command corresponding to selection of transmission between two external apparatuses, and wherein step (c) comprises:
(c1) selecting one of said two external apparatuses as a source and another of said two external apparatuses as a destination;
(c2) determining whether said source and said destination are of a same type;
(c3) when said source and said destination are of the same type, transmitting the data for transmission from the source to the destination; and
(c4) when said source and said destination are not of the same type, converting the data from the source to a form suitable for the destination, and transmitting the converted data to the destination.

22. The data relay method of claim 21, wherein step (c4) further comprises receiving the data for transmission from the source and storing the received data prior to the converting step, and storing the converted data after the converting step and prior to the transmission of the converted data to the destination.
